(19) United States
(12) Patent Application Publication
(10) Pub. No.: US 2008/0107816 A1
(43) Pub. Date: May 8, 2008

(54) Coating composition and coating method for producing imitation pearls

(76) Inventor: Young Nam Rhee, Seoul (KR)

Correspondence Address: PARK LAW FIRM, 3255 WILSHIRE BLVD, SUITE 1110, LOS ANGELES, CA, 90010, US

(21) Appl. No.: 11/592,866

(22) Filed: Nov. 3, 2006

(51) Int. Cl. B05D 1/36; C09D 5/00

(52) U.S. Cl. 427/407.1; 106/169.33

(57) ABSTRACT

Disclosed herein are a coating composition and a coating method for producing imitation pearls.

The coating composition comprises pyroxylin, camphor, an ester-based solvent and a pigment wherein the ester-based solvent consists of a mixture of acetone and ethyl acetate and a mixture of butyl acetate and amyl acetate or is a mixture of ethyl acetate and butyl acetate. The coating method is carried out by coating imitation pearl beads twice or more with the coating composition. Specifically, the imitation pearl beads are sequentially subjected to first coating, second coating and third coating. Also, the imitation pearl beads are repeatedly coated with one composition selected from primer, intermediate and top coating compositions. Also, the imitation pearl beads are repeatedly coated twice or more with two compositions selected from primer, intermediate and top coating compositions.

### BACKGROUND OF THE INVENTION

1. Field of the Invention

The present invention relates to a coating composition and a coating method for producing imitation pearls used in a variety of ornaments, including accessories (e.g., necklaces, bracelets and rings).

2. Description of the Related Art

Developments in modern technology and improvements in life quality have brought about considerable changes in ornaments that people wear or carry on their bodies.

Particularly, imitation pearls are utilized in a wide variety of applications, including accessories, necklaces, rings, brooches and toys, because they can be mass-produced and are similar to natural pearls in terms of texture.

Conventional imitation pearls are produced by dissolving nitrocellulose in a variety of solvents, blending a pigment with the nitrocellulose solution, and coating the blend on resin beads.

Basic lead carbonate, which is a complex salt of a lead (Pb)-containing neutral salt and a hydroxide, is usually used as a pigment to produce imitation pearls. Although basic lead carbonate is effective in creating substantially the same texture and luster as natural pearls, it is fatal to humans and is considered to be a main cause of environmental pollution after use. These problems remain unsolved.

Korean Patent No. 601154 issued to the present applicant, entitled “Coating composition for producing imitation pearls”, and U.S. Pat. No. 6,890,379 issued to the present applicant, entitled “Coating compounds for imitation pearl” (hereinafter, both of which are referred to as “the prior art”), disclose coating compositions and coating methods for producing imitation pearls wherein the coating compositions contain substantially no lead component. According to the prior art, however, since pyroxylin is used in an excessive amount as compared to other components, the coating compositions have the problems of excessively high viscosity, long time required for repetitive coating, thick surface coating, long drying time, high production costs, low production efficiency and low yield of the final products.

### SUMMARY OF THE INVENTION

The present invention has been made in view of the problems of the prior art, and it is one object of the present invention to provide a coating composition for producing imitation pearls that causes no environmental pollution, is harmless to humans when a variety of ornaments produced using the coating composition are worn, is ideal in terms of color and texture, can be artificially dried at high temperature as well as naturally dried at room temperature for a short period of time, and has the advantages of low production costs and high coating efficiency.

It is another object of the present invention to provide a coating method for producing imitation pearls using the coating composition.

In accordance with one aspect of the present invention for achieving the above objects, there is provided a coating composition for producing imitation pearls which comprises 1.5 to 6% by weight of pyroxylin, 0.1 to 0.6% by weight of camphor, 86 to 95% by weight of an ester-based solvent and 1 to 8% by weight of a pigment wherein the ester-based solvent consists of a mixture of acetone and ethyl acetate and a mixture of butyl acetate and amyl acetate or is a mixture of ethyl acetate and butyl acetate.

In accordance with another aspect of the present invention, there is provided a method for producing imitation pearls by coating imitation pearl beads with the coating composition.

### DESCRIPTION OF THE PREFERRED EMBODIMENTS

The present invention will now be described in greater detail.

The present invention provides a composition for coating imitation pearls which comprises 1.5 to 6% by weight of pyroxylin, 0.1 to 0.6% by weight of camphor, 86 to 95% by weight of an ester-based solvent and 1 to 8% by weight of a pigment wherein the ester-based solvent consists of a mixture of acetone and ethyl acetate and a mixture of butyl acetate and amyl acetate or is a mixture of ethyl acetate and butyl acetate.

The camphor functions as a plasticizer.

The ester-based solvent used to dissolve the pyroxylin may consist of a mixture of acetone and ethyl acetate and a mixture of amyl acetate and butyl acetate, or may be a mixture of ethyl acetate and butyl acetate.

The use of acetone and amyl acetate may be omitted. At this time, ethyl acetate and butyl acetate are used instead of the acetone and the amyl acetate, respectively.

Specifically, the coating composition of the present invention may be a primer coating composition, an intermediate coating composition, or a top coating composition.

The primer coating composition comprises 1.5 to 6% by weight of pyroxylin, 30 to 60% by weight of a mixture of acetone and ethyl acetate, 30 to 60% by weight of a mixture of butyl acetate and amyl acetate, 0.1 to 0.6% by weight of camphor, and 3 to 8% by weight of a pigment whose main component is bismuth oxychloride.

The intermediate coating composition comprises 1.5 to 6% by weight of pyroxylin, 15 to 45% by weight of a mixture of acetone and ethyl acetate, 35 to 80% by weight of a mixture of butyl acetate and amyl acetate, 0.1 to 0.6% by weight of camphor, and 1 to 8% by weight of bismuth oxychloride as a pigment.

As for the primer and intermediate coating compositions, the mixture of acetone and ethyl acetate consists of 0 to 30% by weight of the acetone and 70 to 100% by weight of the ethyl acetate, and the mixture of butyl acetate and amyl acetate consists of 70 to 100% by weight of the butyl acetate and 0 to 30% by weight of the amyl acetate.

The top coating composition comprises 1.5 to 6% by weight of pyroxylin, 16 to 38% by weight of ethyl acetate, 40 to 80% by weight of butyl acetate, 0.1 to 0.6% by weight of camphor, and 1 to 8% by weight of bismuth oxychloride as a pigment.

The amount of butyl acetate used in the intermediate coating composition must be higher than that of butyl acetate used in the primer coating composition. The amount of butyl acetate in the top coating composition must be higher than that of butyl acetate used in the intermediate coating composition. This increase in the content of butyl acetate in the respective coating compositions is effective in improving the lubricity and luster of the surface of final imitation pearls.

Since bismuth oxychloride used in the coating composition of the present invention is highly priced, a portion of the bismuth oxychloride may be replaced with titanium dioxide in terms of cost reduction. When a mixture of titanium dioxide and bismuth oxychloride is used, the weight ratio of the titanium dioxide to the bismuth oxychloride is 60-90:10-40.

The present invention also provides a method for preparing the coating composition, the method comprising the steps of mixing 1.5 to 6% by weight of pyroxylin with 86 to 95% by weight of an ester-based solvent to obtain a sticky solution, and adding 1 to 8% by weight of a pigment to the solution, followed by stirring, wherein the ester-based solvent consists of a mixture of acetone and ethyl acetate and a mixture of butyl acetate and amyl acetate or is a mixture of ethyl acetate and butyl acetate.

0.1 to 0.6% by weight of camphor may be added as a plasticizer when the pyroxylin is mixed with the ester-based solvent.

According to the method of the present invention, pyroxylin is previously dissolved in an ester-based solvent consisting of a mixture of acetone and ethyl acetate and a mixture of butyl acetate and amyl acetate, or a mixture of ethyl acetate and butyl acetate. The pyroxylin solution is used as a preliminary solution, which is effective in raising the production efficiency of the final imitation pearls.

The present invention also provides a coating method for producing imitation pearls by coating imitation pearl beads twice or more with the coating composition. Specifically, the imitation pearl beads are sequentially subjected to first coating, second coating and third coating. Also, the imitation pearl beads are repeatedly coated with one composition selected from primer, intermediate and top coating compositions. Also, the imitation pearl beads are repeatedly coated twice or more with two compositions selected from primer, intermediate and top coating compositions.

The primer and intermediate coating compositions are prepared by dissolving pyroxylin and camphor in an ester-based solvent consisting of a mixture of acetone and ethyl acetate and a mixture of butyl acetate and amyl acetate, and adding a pigment to the solution. The top coating composition is prepared by dissolving pyroxylin and camphor in a mixture of ethyl acetate and butyl acetate, and adding a pigment to the solution.

More specifically, the primer coating composition is prepared by dissolving 1.5 to 6% by weight of pyroxylin and 0.1 to 0.6% by weight of camphor in an ester-based solvent consisting of 30 to 60% by weight of a mixture (3:7) of acetone and ethyl acetate and 30 to 60% by weight of a mixture (7:3) of butyl acetate and amyl acetate, and adding 3 to 8% by weight of a pigment to the solution.

The intermediate coating composition is prepared by dissolving 1.5 to 6% by weight of pyroxylin and 0.1 to 0.6% by weight of camphor in an ester-based solvent consisting of 15 to 45% by weight of a mixture (3:7) of acetone and ethyl acetate and 35 to 80% by weight of a mixture (7:3) of butyl acetate and amyl acetate, and adding 3 to 8% by weight of a pigment to the solution.

The top coating composition is prepared by dissolving 1.5 to 6% by weight of pyroxylin and 16 to 18% by weight of camphor in a mixture of 16 to 18% by weight of ethyl acetate and 40 to 80% by weight of butyl acetate, and adding 1 to 8% by weight of a pigment to the solution.

In the preparation of the primer and intermediate coating compositions, acetone and ethyl acetate are preferably mixed together in a weight ratio of 3:7. When acetone is used in an excessively large amount, a strong smell inherent to acetone remains and the coating compositions dry so fast, which makes it difficult to control the balance with subsequent processes. On the contrary, the use of ethyl acetate in an excessively large amount requires a long time to completely dissolve pyroxylin in the ester-based solvent and has a bad influence on the luster of final imitation pearls to be produced.

In the coating method of the present invention, pyroxylin is used instead of nitrocellulose, which is used in conventional coating methods; camphor is used as a plasticizer; general solvents, such as acetone, butyl acetate and ethyl acetate, are used to dissolve the pyroxylin and camphor; and amyl acetate, which is an esterification product of acetic acid and amyl alcohol and is lubricative, is used as another solvent. By mixing the components in a specified ratio, optimum conditions for the production of imitation pearls similar to natural pearls are created.

The weight ratio of butyl acetate to amyl acetate is preferably adjusted to 7:3. If necessary, butyl acetate can be used alone.

As the pigment used in the present invention, a liquid pearl pigment whose major component is bismuth oxychloride, which is the most suitable for creating the luster of natural pearls, is preferred. A mixture of 10 to 40% by weight of a liquid pearl pigment whose major component is bismuth oxychloride and 60 to 90% by weight of a titanium dioxide powder can also achieve relatively satisfactory results.

### EXAMPLE 1

After 0.8 kg of pyroxylin and 0.08 kg of camphor were put into a 20 liter vessel, 3 kg of acetone and 7 kg of ethyl acetate were added thereto. To the mixture were added 7 kg of butyl acetate and 3 kg of amyl acetate with continuous stirring to obtain a sticky solution.

Subsequently, 1.2 kg of bismuth oxychloride was added to the solution with continuous stirring. The resulting mixture was stirred to completely dissolve the pigment particles, yielding a primer coating composition as a viscous liquid.

An intermediate coating composition was prepared in the same manner as in the preparation of the primer coating composition, except that 2.4 kg of acetone, 5.6 kg of ethyl acetate, 8.4 kg of butyl acetate, 3.6 kg of amylacetate, and 1.2 kg of a liquid pearl pigment whose main component is bismuth oxychloride were used.

On the other hand, 0.8 kg of pyroxylin and 0.1 kg of camphor were put into a 20 liter vessel, and then 6 kg of ethyl acetate was added thereto. To the mixture were sequentially added 14 kg of butyl acetate and 0.6 kg of a liquid pearl pigment whose main component is bismuth oxychloride with continuous stirring to obtain a top coating composition.

Imitation pearl beads were coated with the primer coating composition, and dried at 45° C. for 20 minutes. Afterwards, the imitation pearl beads coated with the primer coating composition were coated with the intermediate coating composition, and dried.

Finally, the resulting imitation pearl beads were dipped in the top coating composition and dried to produce final imitation pearls.

The lead content of the imitation pearls was 0.0025% (25 ppm) or less. When an appropriate colorant was added to the imitation pearls to produce a desired color, the same soft, glittering, splendid and mysterious color and luster as those of natural pearls were obtained.

### EXAMPLE 2

Imitation pearls were produced in the same manner as in Example 1, except that the following coating compositions were used: a primer coating composition comprising 0.8 kg of pyroxylin, 0.1 kg of camphor, 3.2 kg of acetone, 7.36 kg of ethyl acetate, 8.5 kg of butyl acetate, 3.66 kg of amyl acetate, and 1.28 kg of a pigment; an intermediate coating composition comprising 0.8 kg of pyroxylin, 0.11 kg of camphor, 2.25 kg of acetone, 5.25 kg of ethyl acetate, 9.45 kg of butyl acetate, 3.05 kg of amyl acetate, and 3 kg of a pigment; and a top coating composition comprising 0.8 kg of camphor, 0.12 kg of acetone, 5.46 kg of ethyl acetate, 12.55 kg of butyl acetate, and 0.27 kg of a pigment.

### EXAMPLE 3

Imitation pearls were produced in the same manner as in Example 1, except that the following coating compositions were used: a primer coating composition comprising 0.9 kg of pyroxylin, 0.07 kg of camphor, 3.15 kg of acetone, 7.35 kg of ethyl acetate, 6.93 kg of butyl acetate, 2.97 kg of amyl acetate, and 0.6 kg of a pigment whose main component is bismuth oxychloride; and an intermediate coating composition comprising 0.8 kg of pyroxylin, 0.1 kg of camphor, 2.4 kg of acetone, 5.6 kg of ethyl acetate, 8.4 kg of butyl acetate, 3.6 kg of amyl acetate, and 1.2 kg of a pigment whose main component is bismuth oxychloride, and imitation pearl beads were repeatedly coated with the primer and intermediate coating compositions without performing top coating.

The imitation pearls thus produced exhibited the same color and luster as those of natural pearls.

### EXAMPLE 4

Imitation pearls were produced in the same manner as in Example 1, except that the following coating compositions were used: a primer coating composition comprising 0.9 kg of pyroxylin, 0.09 kg of camphor, 3.15 kg of acetone, 7.35 kg of ethyl acetate, 6.93 kg of butyl acetate, 2.97 kg of amyl acetate, and 0.6 kg of a pigment whose main component is bismuth oxychloride; and a top coating composition comprising 0.9 kg of pyroxylin, 0.11 kg of camphor, 5.7 kg of ethyl acetate, 15.15 kg of butyl acetate and 0.25 kg of a pigment, and imitation pearl beads were repeatedly coated with the primer and top coating compositions without performing intermediate coating.

The imitation pearls thus produced exhibited the same color and luster as those of natural pearls.

### EXAMPLE 5

Imitation pearls were produced in the same manner as in Example 1, except that an intermediate coating composition comprising 0.8 kg of pyroxylin, 0.11 kg of camphor, 2.4 kg of acetone, 5.6 kg of ethyl acetate, 8.4 kg of butyl acetate, 8.4 kg of butyl acetate, 3.6 kg of amyl acetate and 1.2 kg of a pigment whose main component is bismuth oxychloride was used alone, and imitation pearl beads were repeatedly coated with the intermediate coating composition.

### EXAMPLE 6

Imitation pearls were produced in the same manner as in Example 1, except that the following coating compositions were used: a primer coating composition comprising 0.6 kg of pyroxylin, 0.11 kg of camphor, 3.15 kg of acetone, 7.35 kg of ethyl acetate, 6.93 kg of butyl acetate, 2.97 kg of amyl acetate, and 0.6 kg of a pigment whose main component is bismuth oxychloride; and a top coating composition comprising 0.9 kg of pyroxylin, 0.06 kg of camphor, 5.7 kg of ethyl acetate, 15.15 kg of butyl acetate and 0.35 kg of a pigment whose main component is bismuth oxychloride, and imitation pearl beads were repeatedly coated with the primer and top coating compositions without performing intermediate coating.

The imitation pearls thus produced exhibited the same color and luster as those of natural pearls.

### EXAMPLE 7

Imitation pearls were produced in the same manner as in Example 1, except that a mixture of 0.8 kg of titanium dioxide and 0.4 kg of bismuth oxychloride was used instead of pure bismuth oxychloride and the pigment whose main component is bismuth oxychloride used in the primer and intermediate coating compositions, respectively.

If necessary, the kind and amount of the components contained in the primer, intermediate and top coating compositions may be varied within the ranges defined above.

As in Example 1, it is most preferred to continuously use primer, intermediate and top coating compositions in this order. One of the coating processes may be omitted or repeated.

The coating method of the present invention can be carried out by common techniques, such as spraying, dipping and brushing.

According to the coating method of the present invention, pyroxylin may be used in various forms. For example, after pyroxylin is previously dissolved in acetone, ethyl acetate or a mixture thereof and stored under optimal conditions, the other components are added in the predetermined ratio to the solution.

The contents of the constituent components of the coating composition according to the present invention are not particularly limited. If needed, the kind and content of the constituent components may be varied.

Bismuth oxychloride or a mixture of titanium dioxide and bismuth oxychloride, which is used as the pigment in the coating composition of the present invention, may be replaced by lead carbonate, which is used in conventional coating compositions.

The coating composition of the present invention causes no environmental pollution and provides superior effects in terms of color and luster.

The present invention provides a coating composition for producing imitation pearls which comprises 1.5 to 6% by weight of pyroxylin, 0.1 to 0.6% by weight of camphor, 86 to 95% by weight of an ester-based solvent, and 1 to 8% by weight of a pigment wherein the ester-based solvent consists of a mixture of acetone and ethyl acetate and a mixture of butyl acetate and amyl acetate or is a mixture of ethyl acetate and butyl acetate.

The present invention provides a coating composition for producing imitation pearls and a method for preparing the coating composition. Imitation pearls produced in accordance with the present invention are harmless and nontoxic to humans. According to the present invention, coating time and drying time are shortened, natural drying at room temperature and artificial drying at high temperature for a short period of time are enabled, and low production costs and high yield of imitation pearls are achieved. Therefore, the present invention is suitable for mass production of imitation pearls.

As apparent from the above description, the present invention provides a coating composition for producing imitation pearls and a method for preparing the coating composition. Since the coating composition of the present invention contains no heavy metal, such as lead, it is nontoxic to humans and causes no environmental pollution.

Pyroxylin and bismuth oxychloride are used in much smaller amounts in the coating composition of the present invention than in conventional coating compositions, thus leading to a reduction in preparation costs. Particularly, the use of reduced amounts of pyroxylin and bismuth oxychloride in the coating composition of the present invention results in a 20% reduction in the production costs of imitation pearls.

Since a reduced amount of pyroxylin is used in the coating composition of the present invention, the coating composition is relatively diluted, the coating time is shortened, and drying time, particularly even at room temperature, is shortened. As a result, the present invention contributes to an improvement in the productivity of imitation pearls.

Camphor added as a plasticizer in the coating composition of the present invention serves to control the viscosity of the coating composition and assists in uniformly dispersing a pigment, thereby ensuring good appearance of final products.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A coating composition for producing imitation pearls which comprises 1.5 to 6% by weight of pyroxylin, 0.1 to 0.6% by weight of camphor, 86 to 95% by weight of an ester-based solvent and 1 to 8% by weight of a pigment wherein the ester-based solvent consists of a mixture of acetone and ethyl acetate and a mixture of butyl acetate and amyl acetate or is a mixture of ethyl acetate and butyl acetate.

2. The coating composition according to claim 1, wherein the camphor is used as a plasticizer.

3. The coating composition according to claim 1, wherein the coating composition is a primer coating composition comprising 1.5 to 6% by weight of pyroxylin, 30 to 60% by weight of a mixture of acetone and ethyl acetate, 30 to 60% by weight of a mixture of butyl acetate and amyl acetate, 0.1 to 0.6% by weight of camphor, and 3 to 8% by weight of bismuth oxychloride as a pigment; an intermediate coating composition comprising 1.5 to 6% by weight of pyroxylin, 15 to 45% by weight of a mixture of acetone and ethyl acetate, 35 to 80% by weight of a mixture of butyl acetate and amyl acetate, 0.1 to 0.6% by weight of camphor, and 1 to 8% by weight of bismuth oxychloride as a pigment; or a top coating composition comprising 1.5 to 6% by weight of pyroxylin, 16 to 38% by weight of ethyl acetate, 40 to 80% by weight of butyl acetate, 0.1 to 0.6% by weight of camphor, and 1 to 8% by weight of bismuth oxychloride as a pigment.

4. The coating composition according to claim 3, wherein, in the primer and intermediate coating compositions, the mixture of acetone and ethyl acetate consists of 0 to 30% by weight of the acetone and 70 to 100% by weight of the ethyl acetate, and the mixture of butyl acetate and amyl acetate consists of 70 to 100% by weight of the butyl acetate and 0 to 30% by weight of the amyl acetate.

5. The coating composition according to claim 3, wherein the amount of butyl acetate used in the intermediate coating composition is higher than that of butyl acetate used in the primer coating composition, and the amount of butyl acetate in the top coating composition is higher than that of butyl acetate used in the intermediate coating composition.

6. The coating composition according to claim 3, wherein a portion of the bismuth oxychloride is replaced with titanium dioxide such that the titanium dioxide and the bismuth oxychloride are mixed in a weight ratio of 60-90:10-40.

7. A method for preparing a coating composition, the method comprising the steps of mixing 1.5 to 6% by weight of pyroxylin with 86 to 95% by weight of an ester-based solvent to obtain a sticky solution, and adding 1 to 8% by weight of a pigment to the solution, followed by stirring, wherein the ester-based solvent consists of a mixture of acetone and ethyl acetate and a mixture of butyl acetate and amyl acetate or is a mixture of ethyl acetate and butyl acetate.

8. The method according to claim 7, wherein 0.1 to 0.6% by weight of camphor is added as a plasticizer when the pyroxylin is mixed with the ester-based solvent.

9. The method according to claim 7, wherein the pyroxylin is previously dissolved in an ester-based solvent consisting of a mixture of acetone and ethyl acetate and a mixture of butyl acetate and amyl acetate, or a mixture of ethyl acetate and butyl acetate so that the pyroxylin solution is used as a preliminary solution.

10. A coating method for producing imitation pearls by coating imitation pearl beads twice or more with the coating composition according to claim 1.

11. The method according to claim 10, wherein the imitation pearl beads are sequentially subjected to first coating, second coating and third coating.

12. The method according to claim 11, wherein the imitation pearl beads are repeatedly coated with one composition selected from primer, intermediate and top coating compositions.
